(19) United States
(12) Patent Application Publication
(10) Pub. No.: US 2024/0413435 A1
(43) Pub. Date: Dec. 12, 2024

(54) Method for Producing a Cell Housing for a Battery Cell, and a Cell Housing

(71) Applicant: Bayerische Motoren Werke Aktiengesellschaft, Muenchen (DE)

(72) Inventors: Wonsup HAN, Suwon-Si, Kwonsun-Ku (KR); Hyunchul ROH, Muenchen (DE)

(21) Appl. No.: 18/700,764

(22) PCT Filed: Nov. 4, 2022
(86) PCT No.: PCT/EP2022/080809

§ 371 Date: Apr. 12, 2024

(30) Foreign Application Priority Data
Nov. 15, 2021 (DE) 10 2021 129 641.2

(51) Int. Cl. H01M 50/107; H01M 50/119

(52) U.S. Cl. CPC H01M 50/107; H01M 50/119

(57) ABSTRACT

The present disclosure relates to a method for producing a cell housing for a battery cell. In one form, a method comprises the steps of: (i) mechanically deforming a sheet metal, in particular aluminum or steel, main body to provide a hollow body, wherein the hollow body has a base and a wall, the wall extending at an angle to the base and forming an opening of the hollow body opposite the base, the angle forming a connecting region between the base and the wall; (ii) selectively supplying thermal energy at a predetermined temperature to the connecting region, leaving at least one other region of the hollow body untreated by thermal energy, wherein the predetermined temperature has at least a value such that a volume of a grain of a material structure of the connecting region is increased by the selective supply of the thermal energy.

### BACKGROUND AND SUMMARY

The present invention relates to a method for the production of a cell housing for a battery cell, and a cell housing.

Methods for the production of cell housings are known in the sector of battery cells, in particular lithium ion battery cells. In the case of these methods, metal base bodies can be mechanically deformed to produce a cell housing. In this case, the deformation can cause mechanical stress on individual deformed regions of the cell housing. This mechanical stress can be particularly high in regions of the deformed cell housing where deformation has occurred to a particularly large extent. These regions can be in particular edges of the cell housing which have been formed by the deformation. Regions where mechanical stress is high can be less mechanically stable and become brittle, in particular when a mechanical force acts on these regions.

### SUMMARY OF THE DISCLOSURE

The object of the present invention is to provide a method for the production of a cell housing in which regions of the produced cell housing with mechanical stress are avoided.

A first aspect of the invention relates to a method for the production of a cell housing for a battery cell, comprising the steps: (i) mechanically deforming a sheet metal base body, in particular comprising aluminum or steel, to form a hollow body, wherein the hollow body has a bottom and a wall, wherein the wall extends at an angle to the bottom and opposite to the bottom forms an opening of the hollow body, wherein the angle forms a connecting region between the bottom and the wall; (ii) selectively supplying thermal energy at a predetermined temperature to the connecting region, wherein at least one other region of the hollow body remains untreated by thermal energy, wherein the predetermined temperature has at least one value so that by selectively supplying the thermal energy a volume of a grain of a material structure of the connecting region is increased.

The terms “comprises”, “includes”, “involves”, “features”, “has”, “having”, or any other variation thereof, as may be used herein, are intended to cover a non-exclusive inclusion. For example, a method or device comprising or having a list of elements is not necessarily limited to those elements, but may include other elements not expressly listed or inherent in such a method or such a device.

Further, unless expressly stated to the contrary, “or” refers to an inclusive “or” and not an exclusive “or”. For example, a condition A or B is satisfied by one of the following conditions: A is true (or exists) and B is false (or does not exist), A is false (or does not exist) and B is true (or exists), and both A and B are true (or exist).

The terms “a” or “one” as used herein are defined in the sense of “one or more”. The terms “another” and “a further” and any other variation thereof are to be understood in the sense of “at least one more”.

The term “plurality” as used herein is to be understood in the sense of “two or more”.

For the purposes of the present disclosure, the term “configured” or “set up” to fulfill a specific function (and respective variations thereof) means that the corresponding device is already present in a configuration or setting in which it can perform the function or it can at least be set up—i.e. can be configured—in such a manner that it can perform the function after being appropriately set up. The configuration can be carried out, for example, by setting the parameters of a process sequence or switches or similar to activate or deactivate functions or settings. In particular, the device can have multiple predetermined configurations or operating modes, so that configuration can be carried out by selecting one of these configurations or operating modes.

A method for the production of the cell housing according to the first aspect can be used to reduce mechanical stress that has been built up within the connecting region due to mechanical deformation. The mechanical stress can cause the hollow body to become brittle at the connecting region and to become unstable more quickly with respect to acting mechanical forces. A force acting on the cell housing can also come from inside a battery cell. This can be the case if the battery cell heats up considerably during operation and expands as a result. This can be exacerbated if gas is produced inside the battery cell or inside the cell housing, the gas being able to exert increased pressure on the cell housing due to a higher temperature. By selectively supplying thermal energy to the connecting region, it is possible to increase the volume of a grain or even multiple grains of a material structure of the connecting region. The minimum temperature required for this depends on the material and is known for common metals. This can reduce possible brittleness of the connecting region and allow the connecting region to stretch slightly when a force is applied. A slight extensibility or a slight elasticity can be advantageous for a region that can become brittle. However, increasing the extensibility of the entire cell housing can lead to an unstable cell housing. It is therefore particularly advantageous that thermal energy is selectively supplied to the connecting region, but at least one other region remains thermally untreated. This allows a stable cell housing to be produced. This can improve the safety of a battery cell during operation.

Embodiments of a method for the production are described below, each of which, unless expressly excluded or technically impossible, may be combined with one another and with the other aspects of the invention as further described.

In some embodiments, the method for the production further comprises: (i) fastening an end plate to an end of the wall remote from the bottom so as to close the opening, wherein the fastening forms a fastening region; (ii) selectively supplying thermal energy at a predetermined temperature to the fastening region, wherein the temperature has a value such that selectively supplying the thermal energy increases a volume of a grain of a material structure of the fastening region. As a result, it is possible to reduce mechanical stress that has been built up in the fastening region by fastening the end plate to the wall. This can reduce possible brittleness of the fastening region. This can further improve the safety of a battery cell during operation.

In some embodiments, the fastening is carried out by a mechanically positive-locking connection, in particular by pressing or crimping the end of the wall together with an outer edge of the end plate. The positive-locking connection can be advantageous, since no additional material is required for the connection. In addition, selectively supplying thermal energy according to the invention to this fastening can reduce possible brittleness of the fastening region of the fastening. This can further improve the safety of a battery cell during operation.

In some embodiments, the fastening is carried out by means of a material-locking connection, in particular a laser welding process of the end of the wall to an outer edge of the end plate. This can be advantageous, since a mechanically highly resilient connection can be achieved. In addition, the cell housing can thus be more impermeable to gases and liquids compared to a positive-locking connection. In addition, selectively supplying thermal energy according to the invention to this fastening can reduce the possible brittleness of the fastening region of the fastening. This can further improve the safety of a battery cell during operation.

In some embodiments, mechanical deformation is achieved by deep drawing. This can be advantageous, since deep drawing can at least partially strengthen a metal used. This can be advantageous for cell housings where high strength is desirable.

In some embodiments, the selective supply of thermal energy is performed by a laser. This may be advantageous since a laser beam has a small cross-sectional area on an irradiated object, so that the selective supply of thermal energy can be performed with a high degree of accuracy to the desired regions of the hollow body. Furthermore, a laser suitable for the metal in question can be selected, in particular with regard to its emitted power and an associated wavelength. This enables an effective selective supply of thermal energy.

A second aspect of the invention relates to a cell housing for a battery cell, wherein the cell housing has been produced in particular using the method for the production according to the first aspect, comprising (i) a hollow body, in particular a cuboidal or cylindrical hollow body, having a bottom and a wall, wherein the wall extends at an angle to the bottom and opposite to the bottom forms an opening of the hollow body, wherein the angle forms a connecting region between the bottom and the wall, (ii) the hollow body has a metal having grains of a material structure, wherein the grains in the connecting region have an average first volume, and the grains in another region have an average second volume, wherein the average first volume is greater than the average second volume.

A third aspect of the invention relates to a battery cell comprising a cell housing according to the second aspect.

The features and advantages explained in relation to the first aspect of the invention apply correspondingly to the further aspects of the invention.

### BRIEF DESCRIPTION OF THE DRAWINGS

Further advantages, features and possible applications of the present invention are apparent from the detailed description below in connection with the figures.

FIG. 1 shows is a flow chart illustrating an embodiment of a method according to the invention for the production of a cell housing; and

FIG. 2 schematically shows a battery cell.

### DETAILED DESCRIPTION OF THE DRAWINGS

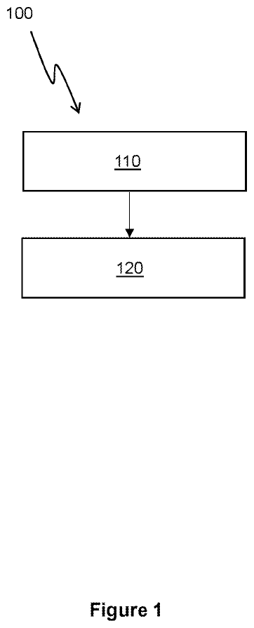

FIG. 1 shows a flow chart 100 illustrating an embodiment of a method according to the invention for the production of a cell housing for a battery cell.

In a first step of the method, a mechanical deformation 110 of a sheet metal base body, in particular comprising aluminum or steel, takes place to form a cylindrical hollow body 210, wherein the cylindrical hollow body 210 has a cylinder bottom 260 and a cylinder wall 270, wherein the cylinder wall 270 extends at an angle α to the cylinder bottom 260 and opposite to the cylinder bottom 260 forms an opening of the cylindrical hollow body 210, wherein a connecting region 300 is formed between the cylinder base 260 and the cylinder wall 270 by the angle α.

In a further step of the method, thermal energy 120 is selectively supplied to the connecting region 300 at a predetermined temperature, wherein at least another region of the hollow cylindrical body 210 remains untreated by thermal energy, wherein the predetermined temperature has a value such that a volume of a grain of a material structure of the connecting region 300 is increased by selectively supplying the thermal energy.

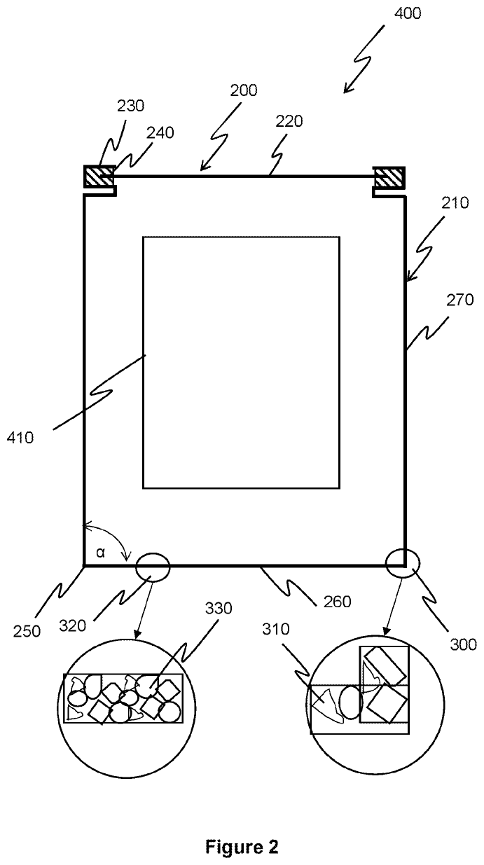

FIG. 2 schematically shows a battery cell 400 having a cell housing 200 and a galvanic unit 410, as can be used in lithium-ion batteries. The galvanic unit 410 can have an electrode stack having an anode and a cathode, as well as a separator. Furthermore, the galvanic unit can have an electrolyte through which electrical charges can be exchanged between the anode and cathode (not shown here). The cell housing 200 was produced using the method according to the invention. The cell housing 200 has a cylindrical hollow body 210 having a cylinder wall 270 and a cylinder bottom 260, as well as an end plate 220 and a fastening ring 230 having a groove. An angle α is formed between the cylindrical wall 270 and a cylindrical bottom 260, which in this case is substantially 90°. The fastening ring 230 can be fastened to the cylindrical hollow body by laser welding. The end plate 220 is fastened in the groove, whereby an electrically insulating element 240 can be fastened between the end plate 220 and the fastening ring 230. As a result, when the anode or the cathode is electrically contacted from outside the cell housing 200, one electrical pole of an anode can be electrically connected to the cylindrical hollow body 210, which in this case is designed to be electrically conductive, and another electrical pole of the cathode can be electrically connected to the end plate, which is also designed to be electrically conductive (not shown here). The electrically insulating element 240 prevents an electrical short circuit during operation. This arrangement is to be understood as an example. Other arrangements for electrically contacting the anode and the cathode are also conceivable.

The mechanical deformation of the base body has created a circumferential bottom edge 250.

The region in the vicinity of the bottom edge 250 is shown enlarged as the first region 300. This first region 300 was selectively supplied with thermal energy, in particular by a laser, as part of the production process. Within the material structure of the cylindrical hollow cylinder 210, first grains 310 of a material structure are arranged in this first region 300, the volumes of the first grains being enlarged by the selective supply of thermal energy. Furthermore, a second region 320 is shown enlarged. Within the material structure of the cylindrical hollow cylinder 210, second grains 330 are arranged in this second region 320. No additional thermal energy was supplied to this second region 280 during the production of the cell housing 200. Therefore, the volumes of the second grains remained substantially unchanged during the production process, wherein the volumes of the individual second grains are smaller than the volumes of the individual first grains. By increasing the volumes of the grains, a slight extensibility of the material can be achieved, thereby reducing potential brittleness.

While at least one exemplary embodiment has been described above, it should be noted that a large number of variations thereto exist. It should also be noted that the exemplary embodiments described are only non-limiting examples, and it is not intended thereby to limit the scope, applicability or configuration of the devices and methods described herein. Rather, the foregoing description will provide the person skilled in the art with guidance for implementing at least one exemplary embodiment, wherein it is understood that various changes in the operating principle and arrangement of the elements described in an exemplary embodiment may be made without departing from the subject matter set forth in each of the appended claims and its legal equivalents.

### LIST OF REFERENCE SYMBOLS

100 Flow chart illustrating a preferred embodiment of the method according to the invention for the production of a cell housing
110 Mechanical deformation
120 Selective supply of thermal energy
200 Cell housing
210 Cylindrical hollow body
220 End plate
230 Fastening ring
240 Electrically insulating element
250 Bottom edge
260 Cylinder bottom
270 Cylinder wall
300 First region
310 First grains
320 Second region
330 Second grains
400 Battery cell
410 Galvanic unit
α Angle

1-8. (canceled)

9. A method for the production of a cell housing for a battery cell, comprising:
mechanically deforming a sheet metal base body to form a hollow body, wherein the hollow body has a bottom and a wall, wherein the wall extends at an angle to the bottom and opposite to the bottom forms an opening of the hollow body, wherein the angle forms a connecting region between the bottom and the wall;
selectively supplying thermal energy at a predetermined temperature to the connecting region, wherein at least one other region of the hollow body remains untreated by thermal energy, wherein the predetermined temperature has at least one value so that by selectively supplying the thermal energy a volume of a grain of a material structure of the connecting region is increased.

10. The method of claim 9, further comprising:
fastening an end plate to an end of the wall remote from the bottom so as to close the opening, wherein the fastening forms a fastening region;
selectively supplying thermal energy at a predetermined temperature to the fastening region, wherein the temperature has a value such that selectively supplying the thermal energy increases a volume of a grain of a material structure of the fastening region.

11. The method of claim 10, wherein the fastening is carried out by a mechanically positive-locking connection.

12. The method of claim 10, wherein the fastening is carried out by means of a material-locking connection.

13. The method of claim 9, wherein mechanical deformation is achieved by deep drawing.

14. The method of claim 9, wherein the selective supply of thermal energy is performed by a laser.

15. A cell housing for a battery cell, comprising:
a hollow body having a bottom and a wall, wherein the wall extends at an angle to the bottom and opposite to the bottom forms an opening of the hollow body, wherein the angle forms a connecting region between the bottom and the wall;
wherein the hollow body (210) has a metal having grains of a material structure, wherein the grains in the connecting region have an average first volume, and the grains in another region have an average second volume, wherein the average first volume is greater than the average second volume.

16. A battery cell comprising the cell housing of claim 15.
